(19) United States
(12) Patent Application Publication
(10) Pub. No.: US 2009/0014905 A1
(43) Pub. Date: Jan. 15, 2009

(54) Extruded sash lock

(76) Inventors: Luke Liang, South Plainfield, NJ (US); Tong Liang, Guangzhou (CN); David Chen, Guang Zhou (CN)

Correspondence Address: BODNER & O'ROURKE, LLP, Suite 108, 425 Broadhollow Road, Melville, NY, 11747, US

(21) Appl. No.: 11/827,102

(22) Filed: Jul. 10, 2007

(51) Int. Cl. B28B 3/20

(52) U.S. Cl. 264/176.1

(57) ABSTRACT

A sash lock having an extruded housing is disclosed. The housing has two open sidewalls. The housing receives a frame, the frame is securable to the underside of the housing. The frame has a sidewall member that forms the sidewall of the housing.

### FIELD OF THE INVENTION

The present invention is directed to improvements in the method of manufacture of sash locks and the sash locks so manufactured. More particularly, the present invention is directed to sash locks manufactured in part by an extrusion process. The present invention also is directed to sash locks that can be made from more than one material, particularly the housing.

### BACKGROUND OF THE INVENTION

Sash locks are commonly used on a pair of sliding windows or on some tilt windows. The sash lock typically has a housing with a handle that rotates a cam or tongue from a first position to a second position. One of the positions is usually a recessed position and the other is an extended or locked position. The tongue or cam usually controls a keeper although sometimes, the tongue extends sufficiently that the keeper is not necessary to prevent movement of one or both of the sashes in a window.

Sash locks are usually made by a casting process where molten metal or plastic is poured into a mold. Once the material has cooled, the casting can be removed for machining of burrs and polishing if desired. Metal casting is a time consuming process because it can take some time for the metal to cool in the mold. Also, casting is expensive because many expensive molds are required to manufacture large quantities of product. As a result, there is a need for an improved process for making sash locks.

### OBJECTS OF THE INVENTION

It is an object of the present invention to provide an improved process for manufacturing sash locks.

It is also an object of the invention to provide an extrusion housing for a sash lock.

It is another object of the invention to provide an extrusion process for manufacturing sash lock covers.

It is a further object of the invention to provide a unique design for a sash lock.

It is still another object of the present invention to provide a lower cost sash lock.

It is a still further object of the present invention to provide an improved composite lock.

### SUMMARY OF THE INVENTION

The present invention is directed to a sash lock that has an outer cover and a separate sidewall. In a preferred embodiment there is an extruded cover and a separate housing. The cover is formed by passing a molten material such as plastic or metal through a die to form a length of extrudate. This length of extrudate has a top surface, a bottom surface and a pair of end surfaces or end walls. Depending on the shape of the die, the extrudate can have a variety of configurations. In one embodiment, the extrudate can have a curved top surface where there are no distinct or separate end walls. Alternatively, the end walls may extend generally at right or other angles to a relatively flat top surface for the extrudate. It will be appreciated that any number of combinations for the configuration of the extrudate are possible.

Once the extrudate is cooled, it is cut generally at right angles to the direction of travel of the extrudate from the die to form a plurality of covers. The resultant cover has a top surface, a bottom surface and usually a pair of end walls or end surfaces. There are no sidewalls in the extruded cover that extend from one end wall to the other end wall and which extend downward from the top surface.

The cover will have one or more, usually three, orifices drilled therein. Two of these orifices typically adjacent to the end walls are for screws or other means to pass through and secure the cover to a sash. The third orifice is for a handle mechanism or operating mechanism that includes a handle, a stem and a cam or tongue. The handle is on the outer surface of the cover. The stem extends from the handle through the cover where it is secured to the cam or tongue. As the handle is rotated, the tongue or cam moves from a first position to a second position. One of the positions is a recessed or unlocked position. The other position is an extended position or a locking position.

Because some customers may object to the open sidewalls of the extruded cover, the sash lock may also include a wall member that seals one of the open sidewalls of the sash lock. The opposite sidewall remains open so that the cam or tongue may extend to a locking position. In a preferred embodiment there is a frame that is secured to the underside of the housing or extruded cover. The frame may be made of any suitable material. However, in order to save costs the frame is preferably made of a plastic material or a relatively inexpensive metal. The frame has a body portion and a side wall portion. The sidewall portion preferably has a shape that conforms to the sidewall profile of the cover, i.e. that portion under the top surface and between the two end walls or end surfaces. This sidewall portion forms a sidewall on one side of the cover. The other sidewall is open to permit the tongue or cam to pass through to lock the window.

The body preferably snaps into the underside of the cover or it can be secured to the cover by means of two orifices which line up to the orifices in the cover for securing the cover to a sash. When the cover is secured to the sash by means of a screw, for example, the screw passes through one or more of the orifices in the body and secures the frame in place.

The cover may be sized so that it extends over a keeper and provides a smooth finish to the surface of the lock and keeper in combination. Alternatively, there is a visually separate sash and keeper. In this second embodiment the sash lock does not have a hood covering the keeper.

### BRIEF DESCRIPTION OF THE DRAWINGS

FIG. 1 is a top view of the sash lock of the present invention with a keeper.

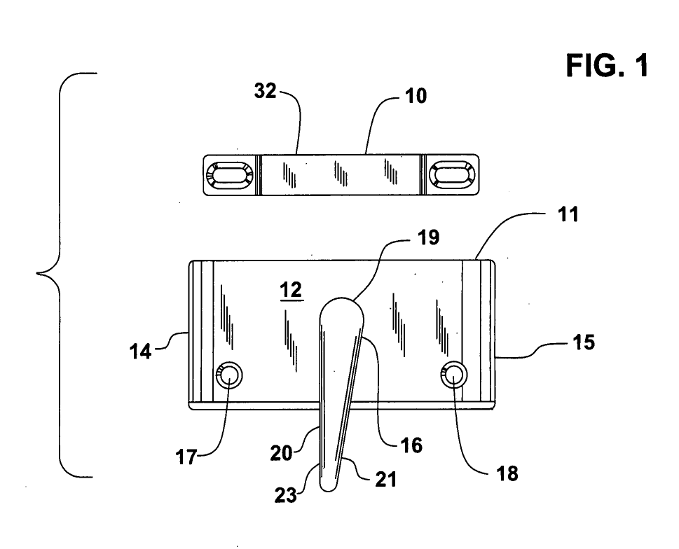

FIG. 2 is a top view of the sash lock of the present invention with the tongue or cam extended.

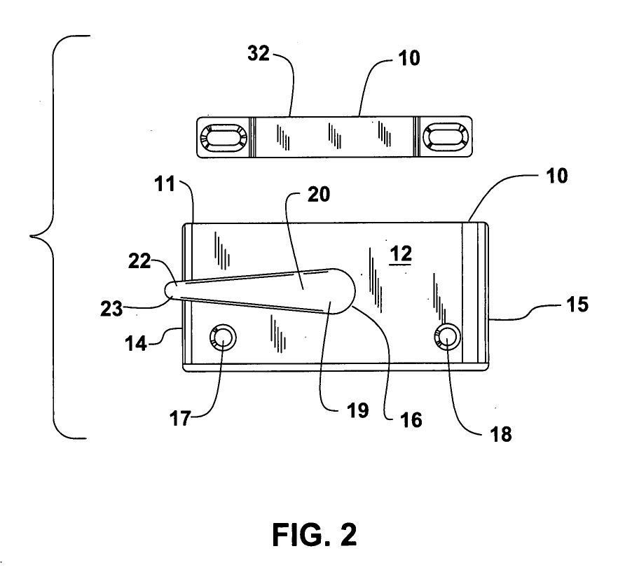

FIG. 3 is an underside view of the sash lock and keeper of FIG. 1.

FIG. 4 is an underside view of the sash lock and keeper of FIG. 2.

FIG. 5 is a side view of the sash lock of FIG. 1 showing the side wall portion of the frame.

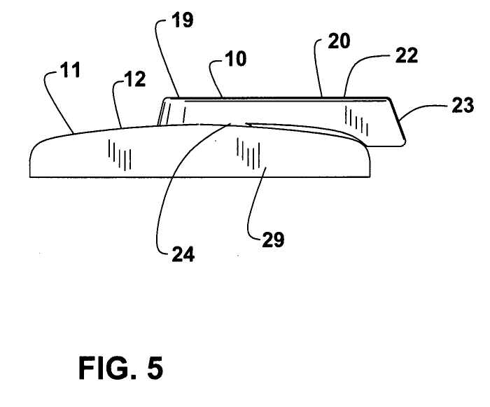

FIG. 6 is a side view of the sash lock of FIG. 5 with the lock in an open position.

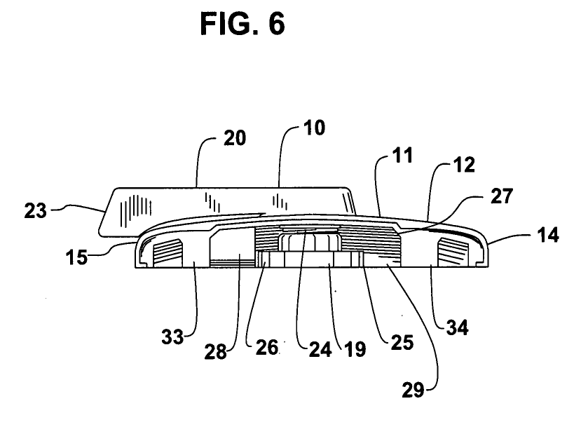

FIG. 7 is a side view of the sash lock of FIG. 5 with the sash lock in a locked position.

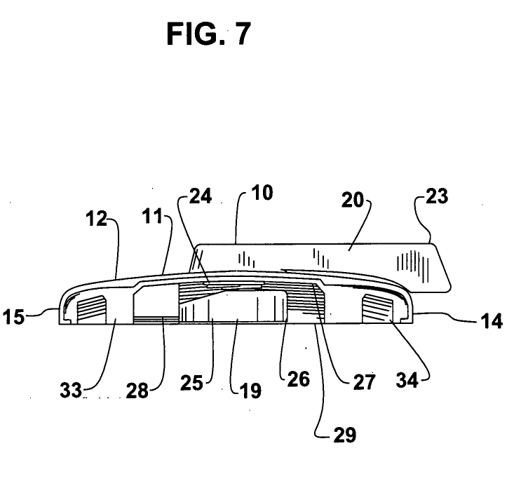

### DETAILED DESCRIPTION OF THE INVENTION

In the present invention there is a cover or housing for a sash lock with open sidewalls that are transverse to the end edges of the cover. At least one of the sidewalls is open to permit a tongue or a portion of a cam to extend outwardly to an extended or locking position. The cover of the present invention may be made by any suitable means. One preferred means of manufacture is by an extrusion process.

A metal or a polymeric material is heated to its melting temperature and is processed in an extruder where it is forced through a die. The die may be any suitable shape for producing an extrudate, preferably a linear extrudate. The shape of the extrudate as it is forced from the die may be curved, generally C shaped or any other suitable shape. There can be any number of decorative designs extruded through the die. Another shape may be a three sided die with a top surface and two end surfaces. The end surfaces may be generally perpendicular to the top surface of the housing or at an angle thereto. It will be appreciated that the shape can vary as desired.

When the molten material passes through the die, it may be cooled by a suitable spray of oil or water. Alternatively, the extrudate may pass through a bath where it is cooled. The extrudate when it comes out of the die has a lengthy top surface. Depending on the shape of the die chosen, the extrudate may have a pair of end walls extending on opposite sides of the top surface. The end walls may extend downwardly from the top surface. The extrudate is cut from one end wall to the opposite end wall to form a plurality of covers. These covers can have a width from one sidewall to the other sidewall that can vary as desired. The covers 11 may have a top surface 12, a bottom surface 13 and a pair of end edges or end walls 14 and 15. The cover or housing has a first side edge and a second side edge on opposite sides of the cover and extending from one end edge to the other. There is no sidewall extending from one end edge or end wall 14 to the opposite end edge or end wall 15. Thus, the cover 11 presents a structure that is open on the two sides. On the top surface 12, there are one or more orifices 16 to 18 present that extend through the top surface 12 to the bottom surface 13. One of these orifices is for the locking mechanism 19. The locking mechanism 19 has a handle 20 that is rotatable from a first position 21 to a second position 22. The handle 20 has a contact surface 23 which the user touches, as well as an arm 24 extending therefrom to a base. Connected to the underside of the base is a stem 25. The stem 25 passes from the handle 20 through the hole or opening 16 in the cover 11 where it is secured to a cam or a tongue 26 under the cover 11. The tongue or cam 26 has a surface that contacts the second sash (not shown) or a keeper 32 on the second sash and prevents either a first sash or a second sash from moving. The other holes 17 and 18, usually two, are present for securing the sash lock cover to a sash. The handle has at least two positions. There is a first position where the tongue or cam is in a recessed or unlocked position. The second position is a locked or extended position. When the cam or tongue is in an extended position, the tongue or cam may contact a keeper, if desired, to lock the sashes. Alternatively, the tongue can extend over the surface of a sash and prevent the sash from moving, thus providing a locking feature.

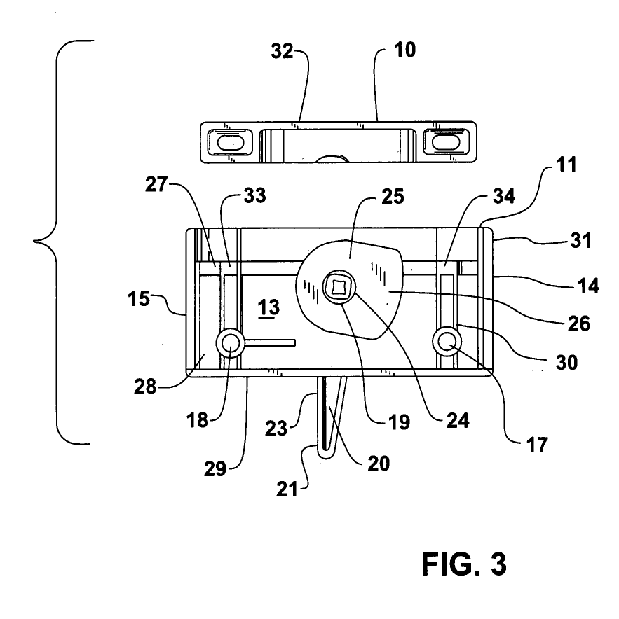

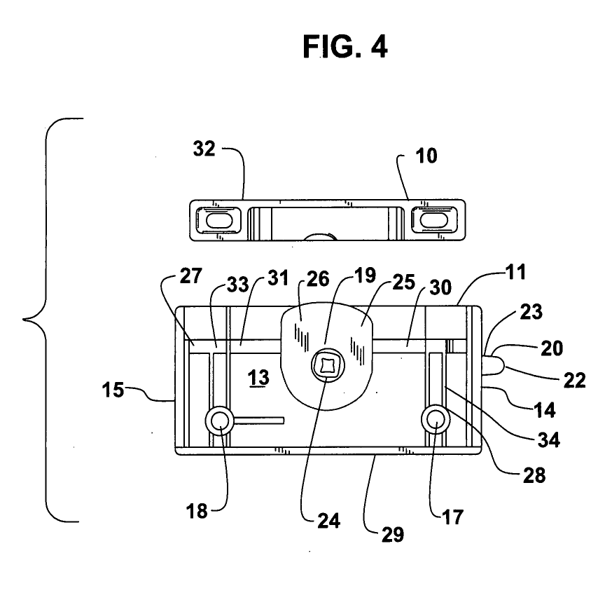

The sash lock 10 also has a separate frame 27. The frame 27 is inserted into the underside of the cover or housing. The frame 27 has a body 28 which has a sidewall 29, generally perpendicular to the body 28. The sidewall 29 forms the sidewall in the sash lock 10 and is positioned with respect to the cover 11 at one side edge of the top surface 12 and extending from one edge 14A of the top surface 12 to the opposite edge 1 5A. The opposite side of the cover remains open to permit the cam or tongue 26 to pass through when the tongue or cam is moved to a locking position. The body 28 of the frame is preferably a generally flat member typically extending from the region of one end edge or end wall of the cover to the other end or end wall of the cover. The body may also be comprised of a framework 30 as well, as seen in FIGS. 3 and 4. This framework has a first member 31 that extends generally from one end of the cover to the opposite end. The first member 31 has two side members 33 and 34 extending generally perpendicular thereto to which secure the sidewall 29 to the frame 27. Each of the side members 33 and 34 are provided with an orifice 16 and 17 which lines up with the openings 16 and 17 in the cover 11 to secure the cover 11 and frame 27 to a sash. The frame 27 in a preferred embodiment may also be snapped into the cover 11, thus eliminating the necessity of orifices in the frame.

The size of the cover may vary. In the figures, the cover is sized to go over any keeper that is present. If a shorter cover is used, then the cover need not hide the keeper.

What is claimed is:

1. A method of forming a housing for a sash lock comprising extruding a molten material through a die to form an extrudate, cooling said extrudate, cutting the extrudate generally at an angle transverse to the direction of travel of said extrudate from said die to form individual one or more housings, each of said housings having a top surface, a bottom surface, first and second side edges and first and second end edges.

2. The method according to claim 1 further comprises forming one or more orifices in said housing.

3. The method according to claim 2 further comprising inserting a stem in said orifice, said stem having a handle on a first end thereof.

4. The method according to claim 3 further comprising securing a cam on a second end of said stem, said handle being positioned over an outer surface of said housing, said cam being positioned on the side of the housing opposite said handle.

5. The method according to claim 2 further comprising inserting a stem in said orifice, said stem having a handle on a first end thereof.

6. The method according to claim 5 further comprising securing a tongue on a second end of said stem, said handle being positioned over an outer surface of said housing, said tongue being positioned on the side of the housing opposite said handle.

7. The method according to claim 2 further comprising inserting a stem in said orifice, said stem having a cam on a first end thereof.

8. The method according to claim 3 further comprising securing a handle on a second end of said stem, said handle being positioned over an outer surface of said housing, said cam being positioned on the side of the housing opposite said handle.

9. The method according to claim 2 further comprising inserting a stem in said orifice, said stem having a tongue on a first end thereof.

10. The method according to claim 5 further comprising securing a handle on a second end of said stem, said handle being positioned over an outer surface of said housing, said tongue being positioned on the side of the housing opposite said handle.

11. The method according to claim 1 further comprising forming three orifices in said housing.

12. The method according to claim 1 further comprising positioning a frame in said housing, said frame having an end portion that forms a sidewall to said housing, said sidewall extending from one side edge of said housing to a position in generally the same plane as at least one of said end edges.

13. The method according to claim 11 wherein said sidewall of said frame has an inner surface and an outer surface and said inner surface of said sidewall has a member extending therefrom, said member having at least one orifice therein for receiving a means for securing said frame to said housing.

14. The method according to claim 12 wherein said housing has two orifices for receiving a means for securing said housing to a sash and wherein said member extending from said inner surface of said sidewall has an orifice positioned therein such that said means for securing said housing can pass through said orifice in said housing and said orifice in said frame.

15. A sash lock comprising an extruded housing, said housing formed by extruding a molten material through a die to form a linear extrudate, cooling said extrudate, cutting the extrudate generally at an angle transverse to the direction of travel of said extrudate from said die to form individual one or more housings, each of said housings having a top surface, a bottom surface, first and second side edges and first and second end edges.

16. The sash lock according to claim 15 further comprising one or more orifices in said housing extending from a top surface in said housing through to a bottom surface in said housing.

17. The sash lock according to claim 16 wherein there is a stem in said orifice, said stem having a handle on a first end thereof.

18. The sash lock according to claim 17 wherein there is a cam on a second end of said stem, said handle being positioned over an outer surface of said housing, said cam being positioned on the side of the housing opposite said handle.

19. The sash lock according to claim 17 wherein there is a tongue on a second end of said stem, said handle being positioned over an outer surface of said housing, said tongue being positioned on the side of the housing opposite said handle.

20. The sash lock according to claim 16 wherein there are three orifices in said housing.

21. The sash lock according to claim 16 wherein a frame is positioned in said housing, said frame having an end portion that forms a sidewall to said housing, said sidewall extending from one side edge of said housing to a position in generally the same plane as at least one of said end edges.

22. The sash lock according to claim 21 wherein said sidewall of said frame has an inner surface and an outer surface and said inner surface of said sidewall has a member extending therefrom, said member having at least one orifice therein for receiving a means for securing said frame to said housing.

23. The sash lock according to claim 22 wherein said housing has two orifices for receiving a means for securing said housing to a sash and wherein said member extending from said inner surface of said sidewall has an orifice positioned therein such that said means for securing said housing can pass through said orifice in said housing and said orifice in said frame.
